(19) United States
(12) Patent Application Publication
(10) Pub. No.: US 2013/0003007 A1
(43) Pub. Date: Jan. 3, 2013

(54) Pixel Electrode And Liquid Crystal Display Panel

(75) Inventor: Xin Zhang, Shenzhen City (CN)

(73) Assignee: SHANGHAI TIANMA MICRO-ELECTRONICS CO., LTD., Shanghai City (CN)

(21) Appl. No.: 13/381,889

(22) PCT Filed: Sep. 29, 2011
(86) PCT No.: PCT/CN2011/080374

§ 371 Date: Dec. 30, 2011

(30) Foreign Application Priority Data
Jul. 1, 2011 (CN) 201110183677X

(51) Int. Cl. G02F 1/1343

(52) U.S. Cl. 349/142

(57) ABSTRACT

A pixel electrode includes strip-like horizontal and vertical main trunks, which perpendicularly intersect at an intersection point coincident with center points of the main trunks. Four pixel domains are formed by being equally divided by the horizontal and vertical main trunks and each of the pixel domains includes flat-laid strip-like branches extending outward at the same included angle with respect to the horizontal main trunk. A spacing distance is formed between adjacent ones of the branches. The branches have distal end sections having a width greater than widths of body sections of the branches. By making the width of the distal end sections of the branches greater than the width of the branches, an area of an edge black zone of the pixel electrode is reduced that reduces an area of a non-open zone to increase an opening rate of liquid crystal display panels and suppress occurrence of disclination lines.

### CROSS REFERENCES TO RELATED APPLICATIONS

This application claims the priority of Chinese Patent Application No. 201110183677.X, of which the title is “A Pixel Electrode and Liquid Crystal Display Panel”, filed with Chinese Patent Office on Jul. 1, 2011, which, in its entirety, is hereby incorporated for reference.

### BACKGROUND OF THE INVENTION

1. Field of the Invention

The present invention relates to the field of liquid crystal displaying techniques, and in particular to a pixel electrode and a liquid crystal display panel.

2. The Related Arts

Liquid crystal displays are gradually getting wide applications as a displaying device for various electronic devices, such as mobile phones, personal digital assistants (PDAs), digital cameras, computer monitor screens, or notebook computer screens. A liquid crystal display device comprises a backlight module and a liquid crystal display panel. The liquid crystal display panel is formed of two substrates and a layer of liquid crystal filled between the two substrates. The manufacturing techniques of the liquid crystal display panel are very diverse and a polymer stabilized vertical alignment (PSVA) liquid crystal display panel is the most common one.

As shown in FIG. 1, FIG. 1 is a schematic view showing a conventional structure of PSVA mode liquid crystal display panel. A typical pixel electrode of PSVA mode liquid crystal display panel is arranged as a snow flake like configuration, which is composed of three portions, including a vertical main trunk 20, a horizontal main trunk 10, and strip-like branches 30 that include an angle of ±45 degrees or ±135 degrees with respect to the x axis. The vertical main trunk 10 and the horizontal main trunk 20 equally divide the pixel area into four domains and each domain is formed by laying flat the electrode branches 113 of 45 degree inclination. The snow flake like configuration shown in FIG. 1 is an electrode arrangement of up-down and left-right mirror symmetry.

FIG. 2 is a schematic view illustrating orientation of liquid crystal with a voltage (0 to 4V) applied to the pixel electrode of FIG. 1. As shown in FIG. 2, when the snow flake like pixel electrode that is generally adopted is energized, liquid crystal shows orientation that is gradually inclined from outside of the pixel electrode toward inside of the pixel electrode and the angle of inclination is along the direction of the strip-like branches. The inclination directions of liquid crystal of the four domains with respect to the horizontal main trunk are respectively ±45 degrees and ±135 degrees and all point to a central zone of the pixel. As shown in FIG. 2, the angles of the orientations of liquid crystal with respect to the horizontal main trunk (X axis) are: −135 degrees for the first quadrant, −45 degrees for the second quadrant, 45 degrees for the third quadrant, and 135 degrees for the fourth quadrant.

The branches of the conventional PSVA pixel electrode are simply of a rectangle (as shown in FIG. 1). Since the known structure of pixel electrode has a weak electric field at an edge, making it completely impossible for liquid crystal to incline at this site. At the locations of the edge of pixel electrode where the electric field is weak, a serrated black zone may occur, affecting the displaying performance of the liquid crystal panel.

### SUMMARY OF THE INVENTION

The present invention provides a pixel electrode and a liquid crystal display panel, which effectively overcome the problem of the prior art liquid crystal display panel that the opening rate is low that leads to low liquid crystal efficiency and high probability of disclination lines.

To overcome the above technical issue, an embodiment of the present invention provides a pixel electrode. The pixel electrode comprises a strip-like horizontal main trunk and a strip-like vertical main trunk, which perpendicularly intersect, an intersection point of the horizontal main trunk and the vertical main trunk being coincident with a center point of the horizontal main trunk and a center point of the vertical main trunk; in four pixel domains that are formed by being equally divided by the perpendicular intersection of the horizontal main trunk and the vertical main trunk, each of the pixel domains comprising a plurality of flat-laid strip-like branches, the plurality of strip-like branches of each of the pixel domains extending outward at a same included angle with respect to the horizontal main trunk, the plurality of strip-like branches having a spacing distance between adjacent ones; the strip-like branches having distal end sections which have a width greater than width of body sections of the strip-like branches.

Preferably, the distal end section of each of the strip-like branches is a polygon of which width gradually increases in a direction of outward extension of the strip-like branch.

The polygon is a trapezoid and the trapezoid has an upper base connected to the body section of the strip-like branch.

The distal end sections of different strip-like branches have sizes that are different or identical.

Preferably, the plurality of strip-like branches forms an included angle of 45 degrees with respect to the horizontal main trunk and the vertical main trunk, and the plurality of strip-like branches of each of the pixel domains is arranged parallel.

Preferably, the plurality of strips of each of the pixel domains has identical spacing between adjacent ones.

Preferably, the plurality of strips of each of the pixel domains has different spacing between every two strips.

Preferably, the four pixel domains that are formed by being equally divided by the perpendicular intersection of the horizontal main trunk and the vertical main trunk are of mirror symmetry in up-down direction and left-right direction.

Preferably, the pixel electrode, as a whole, shows a snow flake like configuration.

Correspondingly, an embodiment of the present invention provides a liquid crystal display panel. The liquid crystal display panel comprises a pixel electrode, wherein the pixel electrode comprises a strip-like horizontal main trunk and a strip-like vertical main trunk, which perpendicularly intersect, an intersection point of the horizontal main trunk and the vertical main trunk being coincident with a center point of the horizontal main trunk and a center point of the vertical main trunk; in four pixel domains that are formed by being equally divided by the perpendicular intersection of the horizontal main trunk and the vertical main trunk, each of the pixel domains comprising a plurality of flat-laid strip-like branches, the plurality of strip-like branches of each of the pixel domains extending outward at a same included angle with respect to the horizontal main trunk, the plurality of strip-like branches having a spacing distance between adjacent ones; the strip-like branches having distal end sections which have a width greater than width of body sections of the strip-like branches.

In the embodiments of the present invention, by making the width of distal end sections (edge portions) of strip-like branches of a pixel electrode greater than width of the strip-like branches, the area of the distal end section containing ITO is remarkably increased and the electric field at the edge portions of the strip-like branches of the pixel electrode is strengthened, making the liquid crystal within the area better orienting and the area of edge black zone of the pixel electrode reduced, so as to reduce the area of non-open zone to increase the opening rate of the liquid crystal display panel and provide an effect of suppressing probability of occurrence of disclination lines.

### BRIEF DESCRIPTION OF THE DRAWINGS

To more clearly describe the technical solution of the embodiments according to the present invention or the prior art techniques, a brief description of the drawings that are necessary for the illustration of the embodiments or the prior art will be given as follows. Apparently, the drawings described below show only embodiments of the present invention and for those having ordinary skills in the field, other drawings may be easily obtained from these drawings without paying any creative effort.

FIG. 1 is a schematic view showing a structure of a conventional PSVA (Polymer Stabilized Vertical Alignment) mode liquid crystal display panel;

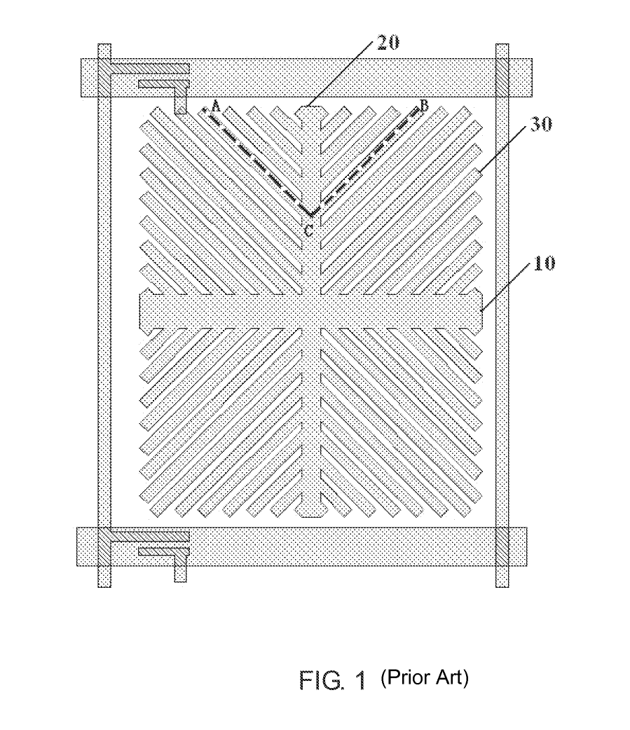

FIG. 2 is a schematic view illustrating orientation of liquid crystal with a voltage applied to the pixel electrode of FIG. 1;

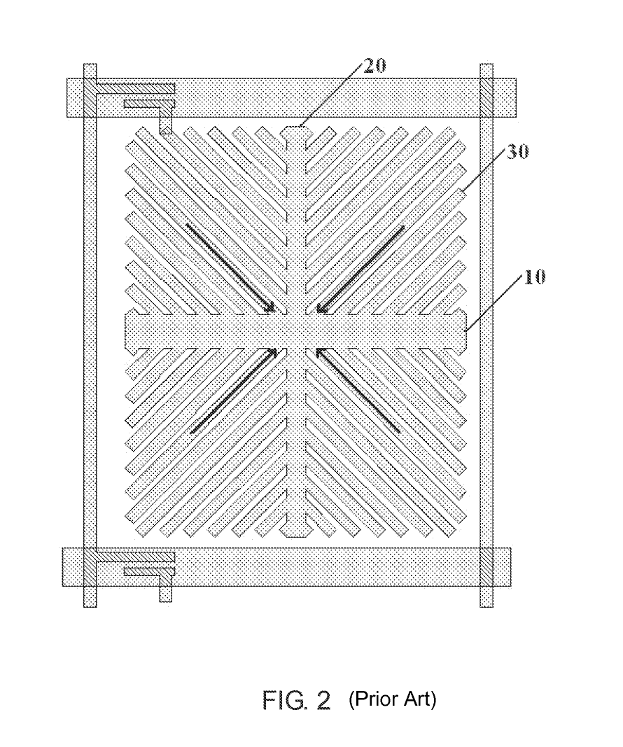

FIG. 3 is a schematic view illustrating a pixel electrode according to an embodiment of the present invention; and

FIG. 4 is a schematic view illustrating a unit pixel electrode of a liquid crystal display panel according to an embodiment of the present invention.

### DETAILED DESCRIPTION OF THE PREFERRED EMBODIMENTS

In view of the problem of the conventional liquid crystal display panel that the opening rate is low that leads to low liquid crystal efficiency and high probability of disclination lines, the present invention provides a novel pixel electrode and a liquid crystal display panel comprising the pixel electrode in order to effectively overcome the problem.

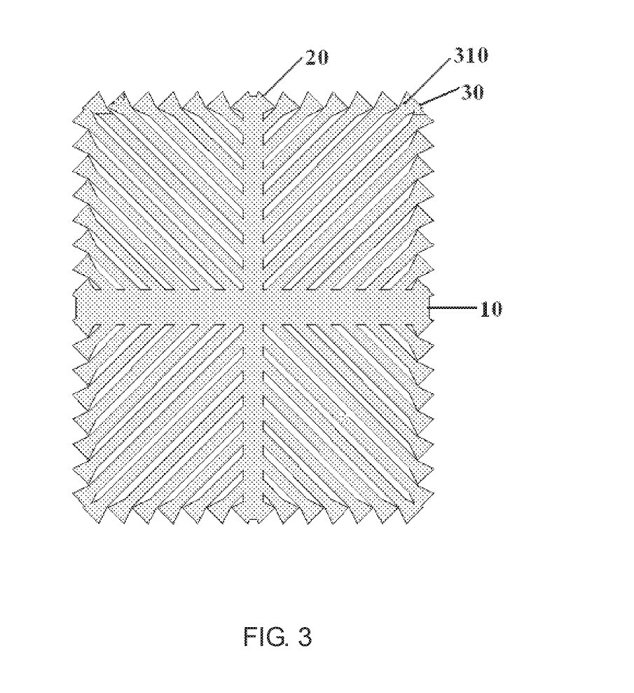

As shown in FIG. 3, FIG. 3 is a schematic view illustrating an electrode pixel according to an embodiment of the present invention. The electrode pixel provided by the present invention comprises a strip-like horizontal main trunk 10 and a strip-like vertical main trunk 20, which perpendicularly intersect. The intersection point of the horizontal main trunk 10 and the vertical main trunk 20 is coincident with the center point of the horizontal main trunk 10 and the center point of the vertical main trunk 20. In four pixel domains that are formed by being equally divided by the perpendicular intersection of the horizontal main trunk 10 and the vertical main trunk 20, each pixel domain comprises a plurality of flat-laid strip-like branches 30. The plurality of strip-like branches 30 of each pixel domain extends outward at the same included angle with respect to the horizontal main trunk 10. The plurality of strip-like branches 30 has a spacing distance between adjacent ones. The strip-like branches 30 have distal end sections 310 which have a width greater than width of body sections of the strip-like branches 30. Here, a distal end section refers to a portion of a strip-like branch 30 that is distant from the horizontal main trunk 10 or the vertical main trunk 20 (an edge portion of the strip-like branch 30). Since the width of the distal end sections 310 of the strip-like branches 30 is greater than the width of the strip-like branches 30, this remarkably increases the area of indium tin oxide (ITO, so that electric field at the edges of the strip-like branches of the pixel electrode can be increased, the liquid crystal at this area can be better oriented, and area of an edge black zone of the pixel electrode is reduced to thereby reduce the area of non-open regions and thus increasing the opening rate and realizing an effect of suppressing the probability of occurrence of disclination lines.

Also, the distal end section illustrated in FIG. 3 is trapezoid, but it is apparent that other polygons may also be applicable. Further, within the same pixel electrode, the distal end sections of different strip-like branches can be of different sizes, or the same size, or partial identical and partial different.

In the embodiment of the present invention, the material that makes the pixel electrode is indium tin oxide or indium zinc oxide or amorphous indium tin oxide. Further, in a practical application, it only needs to design the width of the distal end sections 310 of the strip-like branches (the edge portions of the branches) to be greater than the width of the body sections of the strip-like branches 30 (namely the other portions of the strip-like branches rather than the distal end sections). For example, to better effect the above discussed advantages, in some embodiments of the present invention, the distal end sections of the strip-like branches can each be designed as a polygon of which the width gradually increases in a direction of outward extension of the strip-like branches. For example, the polygon can be a trapezoid and the trapezoid has an upper base connected to the body section of the strip-like branches. A circle, a triangle, a quadrilateral, a rectangle, or a square may alternatively be used, provided an effect that the distal end section of the strip-like branches is expanded with adjacent the strip-like branches being not in contact with each other (as shown in FIG. 3, in which some the distal end sections seem in partial contact with each other due to factors including resolution, but they are actual not in contact with each other) is obtained. ITO area of such distal end sections 310 is remarkably increased.

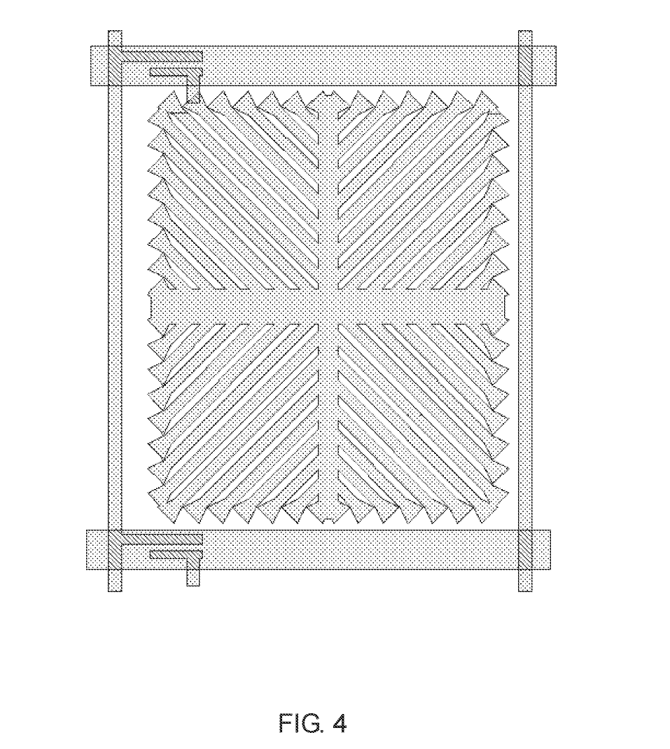

As shown in FIG. 4, FIG. 4 is a schematic view illustrating a liquid crystal display panel according to an embodiment of the present invention. In an actual application, a spacing distance of the strip-like branches 30 refers to the width of a gap between every two strip-like branches 30. A portion of the width of the distal end section 310 of a strip-like branch 30 being greater than the width of the body section of a strip-like branch 30 refers to the opposite side parts of the width of the distal end section 310 that exceed beyond the width of the remaining portion of the strip-like branch 30. The widths of the two opposite side parts are respectively less than the spacing with respect to the corresponding strip-like branch 30.

Further, in the embodiment of the present invention, as shown in FIG. 4, the plurality of strip-like branches 30 forms an include angle of 45 degrees with respect to both the horizontal main trunk 10 and the vertical main trunk 20 and the plurality of strip-like branches 30 contained in each pixel domain is arranged parallel. To better keep the part of the width of the distal end section 310 of a strip-like branch 30 that is greater than the width of the strip-like branch 30 from exceeding the spacing between the strip-like branch 30 and an adjacent strip-like branch 30 and make the areas of the edge parts identical, optionally, identical spacing can be arranged between adjacent ones of the plurality of strips within each pixel domain. Of course, it is also feasible that the spacing between every two strips of the plurality of strips of each pixel domain is made different.

It is seen from FIG. 3 that, preferably, the four pixel domains that are formed by being equally divided by the perpendicular intersection of the horizontal main trunk 10 and the vertical main trunk 20 are of mirror symmetry in up-down direction and left-right direction and the pixel electrode, as a whole, shows a snow flake like configuration.

The pixel electrode according to the embodiment of the present invention is applicable to a PSVA liquid crystal display panel or a pattern vertical alignment (PVA) liquid crystal display panel.

As shown in FIG. 4, FIG. 4 is a schematic view illustrating a unit pixel electrode of a liquid crystal display panel according to an embodiment of the present invention. An embodiment of the present invention also provides a liquid crystal display panel. The panel comprises the pixel electrode of the previously described embodiment. The details of the structure of the pixel electrode may refer to the previous embodiment of the pixel electrode and repeated description is omitted here. Adopting the pixel electrode is helpful in better orienting liquid crystal and reducing the area of edge black zone of the strip-like branches so as to increase the opening rate of the liquid crystal display panel and facilitate suppressing the occurrence of disclination lines in the pixel.

In summary, although the present invention has been described with reference to the preferred embodiment thereof, the preferred embodiment is not to limit the scope of the present invention. Various variations and modifications can be contemplated by those having ordinary skills in the art without departing from the spirits and scope of the present invention and thus, the scope of protection provided by the present invention is determined by the appended claims.

The description given above is a preferred embodiment of the present invention and it is noted that for those having ordinary skills of the art, numerous improvements and modifications can be made without departing the principles of the present invention. Such improvements and modifications are considered within the scope of protection of the present invention.

1. A pixel electrode, wherein the pixel electrode comprises a strip-like horizontal main trunk and a strip-like vertical main trunk, which perpendicularly intersect, an intersection point of the horizontal main trunk and the vertical main trunk being coincident with a center point of the horizontal main trunk and a center point of the vertical main trunk; in four pixel domains that are formed by being equally divided by the perpendicular intersection of the horizontal main trunk and the vertical main trunk, each of the pixel domains comprising a plurality of flat-laid strip-like branches, the plurality of strip-like branches of each of the pixel domains extending outward at a same included angle with respect to the horizontal main trunk, the plurality of strip-like branches having a spacing distance between adjacent ones; the strip-like branches having distal end sections which have a width greater than widths of body sections of the strip-like branches.

2. The pixel electrode as claimed in claim 1, wherein the distal end section of each of the strip-like branches is a polygon of which width gradually increases in a direction of outward extension of the strip-like branch.

3. The pixel electrode as claimed in claim 2, wherein the polygon is a trapezoid and the trapezoid has an upper base connected to the body section of the strip-like branch.

4. The pixel electrode as claimed in claim 1, wherein the distal end sections of different strip-like branches have sizes that are different or identical.

5. The pixel electrode as claimed in claim 1, wherein the plurality of strip-like branches forms an included angle of 45 degrees with respect to the horizontal main trunk and the vertical main trunk, the plurality of strip-like branches of each of the pixel domains being arranged parallel.

6. The pixel electrode as claimed in claim 5, wherein the plurality of strips of each of the pixel domains has identical spacing between adjacent ones.

7. The pixel electrode as claimed in claim 5, wherein the plurality of strips of each of the pixel domains has different spacing between every two strips.

8. The pixel electrode as claimed in claim 1, wherein the four pixel domains that are formed by being equally divided by the perpendicular intersection of the horizontal main trunk and the vertical main trunk are of mirror symmetry in an up-down direction and a left-right direction.

9. The pixel electrode as claimed in claim 8, wherein the pixel electrode shows a snow flake like configuration.

10. A liquid crystal display panel, wherein the liquid crystal display panel comprises the pixel electrode according to claim 1.
